(19) United States
(12) Patent Application Publication
(10) Pub. No.: US 2008/0055918 A1
(43) Pub. Date: Mar. 6, 2008

(54) Vehicular lamp assembly having multiple moveable reflectors

(76) Inventor: Anthony Peter Mascadri, Mechanicsburg, OH (US)

Correspondence Address: ULMER & BERNE, LLP, 600 VINE STREET, SUITE 2800, CINCINNATI, OH, 45202, US

(21) Appl. No.: 11/513,664

(22) Filed: Aug. 31, 2006

(51) Int. Cl. B62J 6/00

(52) U.S. Cl. 362/475; 362/518; 362/298; 362/464

(57) ABSTRACT

A vehicular lamp assembly, such as a headlight, can be configured for attachment to a vehicle for providing illumination about the exterior of a vehicle. The lamp assembly can include a light source configured to emit light during use, a lens, first and second reflectors, and an actuator assembly. The first and second reflectors can be positioned to reflect light emitted from the light source through the lens and can be moveable with respect to the light source. The actuator assembly can be configured to move the first and second reflectors with respect to the light source in response to at least one control signal. The lamp assembly can be configured such that, during use, the first and second reflectors are positioned to reflect light from the light source through the lens. A vehicle including a control system and a headlight having multiple moveable reflectors is also provided.

### TECHNICAL FIELD

The present invention relates to a vehicular lamp assembly, such as a headlight, that includes multiple moveable reflectors. Through movement of these reflectors, an adjustable light pattern can be provided by the lamp assembly.

### BACKGROUND OF THE INVENTION

In recent years, vehicle manufacturers have begun to incorporate articulating headlights into certain vehicles. When such a vehicle is steered into a curve, these headlights rotate to project light around the curve so that a driver can better see the road and can avoid collisions with objects that lie just beyond the curve. However, when a conventional articulating headlight rotates to illuminate an upcoming curve, the area ahead of the vehicle not in the direction of the curve is often no longer adequately illuminated. If an obstacle suddenly presents itself in front of the vehicle in a direction different than that of the curve, then that obstacle might not be sufficiently illuminated by the articulating headlight to enable a driver to see the obstacle and quickly respond. There are also other circumstances in which conventional headlights do not provide adequate illumination.

### SUMMARY OF THE INVENTION

One embodiment of the present invention involves a vehicular headlight that has multiple moveable reflectors. The headlight can include a light source configured to emit light during use, a lens, first and second reflectors, and an actuator assembly. The first and second reflectors can be positioned to reflect light emitted from the light source through the lens and can be moveable with respect to the light source. The actuator assembly can be configured to move the first and second reflectors with respect to the light source in response to at least one control signal. The vehicular headlight can be configured such that, during use, the first and second reflectors are positioned to reflect light from the light source through the lens.

In accordance with another exemplary embodiment of the present invention, a lamp assembly is configured for attachment to a vehicle for providing illumination about the exterior of a vehicle. The lamp assembly can include a light source configured to emit light during use, a lens, first and second reflectors, and an actuator assembly. The first and second reflectors can be positioned to reflect light emitted from the light source through the lens and can be moveable with respect to the light source. The actuator assembly can be configured to move the first and second reflectors with respect to the light source in response to at least one control signal. The lamp assembly can be configured such that, during use, the first and second reflectors remain positioned to continually reflect light from the light source through the lens.

In accordance with yet another exemplary embodiment of the present invention, a vehicle is provided that includes a control system and a headlight. The control system can be configured to generate one or more control signals. The headlight can comprise a light source that is configured to emit light during use, a lens, and first and second reflectors positioned to reflect light emitted from the light source through the lens. The first and second reflectors can be moveable with respect to the light source. The headlight can further comprise an actuator assembly configured to move the first and second reflectors with respect to the light source in response to the control signal(s). The headlight can be configured such that, during use, the first and second reflectors are positioned to reflect light from the light source through the lens.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a side view depicting a motorcycle having a headlight in accordance with one exemplary embodiment of the present invention;

FIG. 2 is an enlarged perspective view depicting the headlight of FIG. 1;

FIG. 3 is a cross-sectional view taken along section lines 3-3 in FIG. 2 and depicting certain internal components of the headlight of FIG. 2;

FIG. 4 is a cross-sectional view depicting certain internal components of a headlight in accordance with another exemplary embodiment of the present invention;

FIG. 5 is a front elevational view depicting the reflector assembly of the exemplary headlight depicted in FIG. 3;

FIG. 6 is a front elevational view depicting a reflector assembly in accordance with another exemplary embodiment of the present invention;

FIG. 7 is a front elevational view depicting a reflector assembly in accordance with yet another exemplary embodiment of the present invention;

FIG. 8 is a front elevational view depicting a reflector assembly in accordance with still another exemplary embodiment of the present invention;

FIG. 9 is a front elevational view depicting a reflector assembly in accordance with another exemplary embodiment of the present invention;

FIG. 10 is a front elevational view depicting a reflector assembly in accordance with another exemplary embodiment of the present invention;

FIG. 11 is a front elevational view depicting a reflector assembly in accordance with still another exemplary embodiment of the present invention;

FIG. 12 is a front elevational view depicting a reflector assembly in accordance with yet another exemplary embodiment of the present invention;

FIG. 13 is a front elevational view depicting a reflector assembly in accordance with yet another exemplary embodiment of the present invention;

FIG. 14 is a front elevational view depicting a reflector assembly in accordance with still another exemplary embodiment of the present invention;

FIG. 15 is a front elevational view depicting a reflector assembly in accordance with another exemplary embodiment of the present invention; and

FIG. 16 is a block diagram depicting an exemplary control system and lamp assembly in accordance with another embodiment of the present invention.

### DETAILED DESCRIPTION OF EXEMPLARY EMBODIMENTS

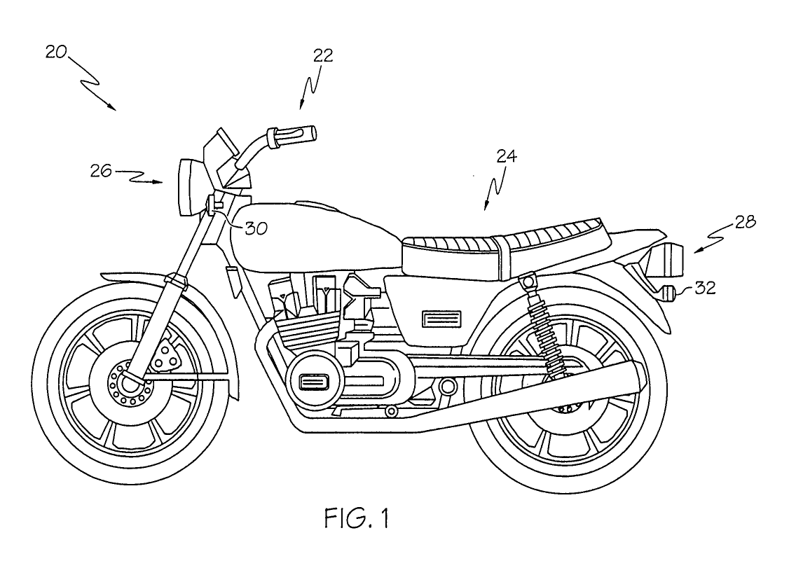

The present invention and its operation is hereinafter described in detail in connection with the views and examples of FIGS. 1-16, wherein like numbers indicate the same or corresponding elements throughout the views. FIG. 1 depicts a motorcycle 20 having handlebars 22, a seat 24, a headlight 26, a taillight 28, front turn signals (e.g., 30), and rear turn signals (e.g., 32). A lamp assembly in accordance with the teachings of the present invention can be associated with at least one of the headlight 26, the taillight 28, the front turn signals (e.g., 30), the rear turn signals (e.g., 32), and/or one or more other lights present on the motorcycle 20.

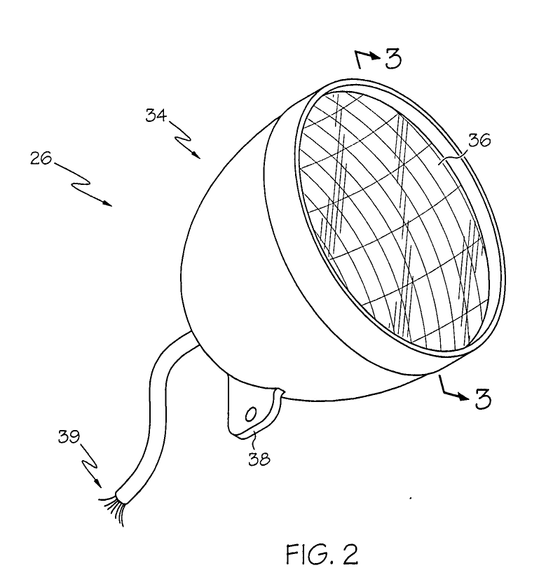

For example, the headlight 26 of the motorcycle 20 can comprise a lamp assembly in accordance with the teachings of the present invention. In particular, the exemplary headlight 26 is shown in further detail in FIG. 2 and includes a housing 34 and a lens 36. The housing 34 can include a mounting bracket 38 to facilitate connection of the headlight 26 to the motorcycle 20. During use, light will emanate from the headlight 26 through the lens 36, and the lens 36 can have a fixed position with respect to the housing 34 and with respect to a light source within the housing 34 (discussed below). However, the lens 36 might alternatively be moveable during use with respect to the housing 34 and/or the light source. Wires 39 can protrude from the housing 34 for connection to power and/or control signals, although a lamp assembly might alternatively be wirelessly configured such that all power and/or control signals are generated from within the housing.

FIG. 3 is a cross-sectional view depicting certain of the internal components of the exemplary headlight 26. In particular, in addition to those components already discussed, the headlight 26 includes a light source 49. In the exemplary embodiment shown, the light source 49 comprises a light bulb such as a standard incandescent bulb, a halogen bulb, or a high-intensity discharge type bulb. Alternatively, the light source 49 can comprise any of a variety of other structures which emit light, such as a fluorescent bulb, one or more LEDs, or any of a variety of known or hereafter developed light-emitting arrangements. Although the exemplary light source 49 is depicted as a single light bulb, it should be appreciated that the light source may comprise multiple light-emitting structures, such as two or more light bulbs. In addition, non-electrically powered light sources can be used, such as a gas powered flame or a radioactive source (e.g., a tritium capsule).

A reflector assembly 40 is also provided and is configured to receive light from the light source 49 and direct this light through the lens 36 and out from the headlight 26. The reflector assembly 40 can have any of a variety of particular configurations in accordance with the teachings of the present invention, a few of which are described herein. It will be appreciated that an exemplary lamp assembly can include a reflector assembly having any number of reflectors arranged in any of a variety of specific configurations, provided, however, that at least two moveable reflectors are provided and are configured and positioned to simultaneously reflect respective portions of light emitted from the light source through the lens. In other words, these at least two reflectors receive respective portions of light emitted by the light source, and then direct these respective portions of light for passage through the lens. The reflectors are moveable such that portions of the light emitted from the light source may be directed through the lens along different paths by movement of the reflectors.

For instance, an exemplary reflector assembly 40 can include at least two movable reflectors, and can further include one or more additional reflectors that are moveable and/or fixed in place. In particular, the reflector assembly 40 depicted in FIG. 3 is shown to include a first reflector 41 and a second reflector 42. The first reflector 41 can be hingedly coupled (via hinge 80) to the housing 34 such that the first reflector 41 is moveable with respect to the housing 34, the lens 36, and/or the light source 49. Likewise, the second reflector 42 can be hingedly coupled (via hinge 82) to the housing 34 such that the second reflector 42 is also moveable with respect to the housing 34, the lens 36 and/or the light source 49. Movement of the first and second reflectors 41, 42 will affect the manner in which light is projected from the headlight 26, and in the case of a headlight, can resultantly change the manner in which illumination is provided ahead of a particular vehicle (e.g., motorcycle 20).

The first and second reflectors 41, 42 are shown as being distinct from one another. It should be appreciated, however, that the first and second reflectors can alternatively be integrally provided as a single component (e.g., that is sufficiently flexible to allow movement of the first reflector with respect to the second reflector). Also, the first and second reflectors 41, 42 are shown in FIG. 3 as being spaced away from one another. It should be appreciated, however, that the first and second reflectors may alternatively be configured such that they can selectively or permanently contact and/or connect with one another.

The reflector assembly can also include a third reflector (e.g., 43, shown in FIG. 5) which also can be positioned to reflect light emitted from the light source through the lens. The third reflector can be distinct from the first and second reflectors and can either be moveable with respect to the light source or can have a fixed position with respect to the light source. Of course, any number of additional reflectors can be provided (moveable and/or fixed), as will be apparent in the examples that are discussed herein with respect to FIGS. 5-15.

Referring again to FIG. 3, an actuator assembly 50 can be provided within the housing 34 or can otherwise be associated with the headlight 26. The actuator assembly 50 can be configured to cause movement of one or more reflectors (e.g., 41, 42) within a reflector assembly (e.g., 40) in response to at least one control signal. In the exemplary embodiment shown in FIG. 3, the actuator assembly 50 may comprise a first actuator 52 and a second actuator 54. The first and second actuators 52, 54 can comprise servos, pistons, and/or any of a variety of other devices that can cause movement of one or more reflectors (e.g., 41, 42) of a reflector assembly (e.g., 40). For example, the first actuator 52 can comprise a servo having an arm 53 that connects with the first reflector 41. Likewise, the second actuator 54 can comprise a servo having an arm 55 that connects with the second reflector 42. The actuators 52, 54 can be configured such that they can variably displace the arms 53, 55, respectively, in response to one or more control signals, such that the first and second reflectors 41, 42 can be adjustably positioned. Control signals to operate the first and second actuators 52, 54 can be received through the wires 39, as can power for the light source 49.

Although FIG. 3 depicts an actuator assembly 50 having an individual actuator 52, 54 for each individual reflector 41, 42, it will be appreciated that an actuator assembly 50 could alternatively comprise a single actuator coupled with more than one reflector in order to provide synchronized movement of multiple reflectors. However, by providing an individual actuator for each reflector, as shown in the example of FIG. 3, independent or synchronized movement of the individual reflectors can be achieved. It should be appreciated that an actuator assembly can be provided in any of a variety of alternative configurations.

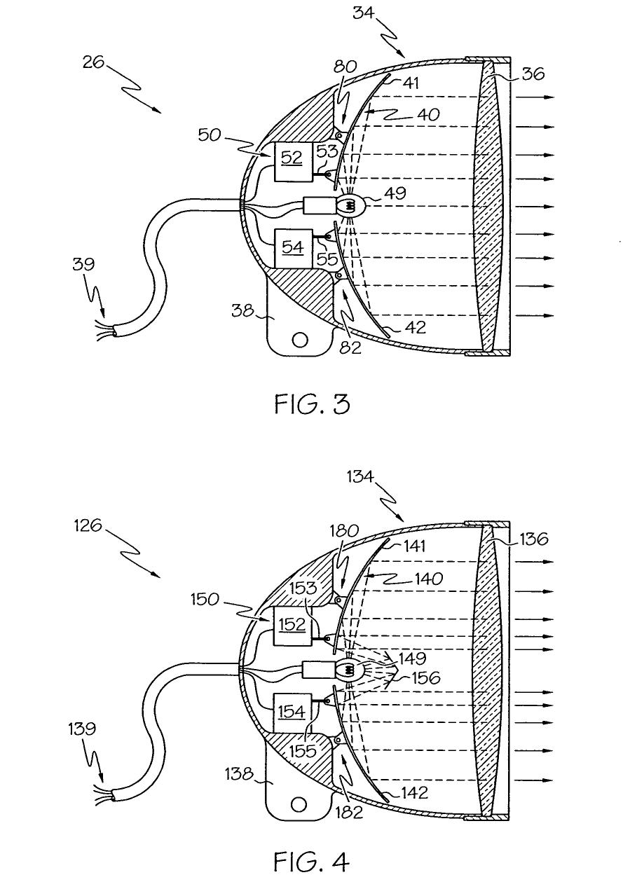

FIG. 4 is a cross-sectional view depicting a headlight 126 having a housing 134, a lens 136, a light source 149 (e.g., a light bulb), a reflector assembly 140 and an actuator assembly 150. The reflector assembly 140 is shown to include a first reflector 141, a second reflector 142 and a hood 156. The actuator assembly 150 is shown to include a first actuator 152 having an arm 153 that connects with the first reflector 141, and a second actuator 154 having an arm 155 that connects with the second reflector 142. The first reflector 141 is shown to be moveably connected to the housing 134 through a hinge 180, and the second reflector 142 is shown to be moveably connected to the housing 134 through a hinge 182. The housing 134 can include a mounting bracket 138 to facilitate attachment of the headlight 126 to a vehicle, and one or more wires 139 can be provided to facilitate transmission of control and/or power signals to the light source 149 and/or the actuator assembly 150.

The hood 156 can be positioned between the light source 149 and the lens 136, and can be configured to intercept and reflect toward the first and/or second reflector(s) 141, 142 at least some of the light emitted by the light source 149. The first and/or second reflector(s) 141, 142 can intercept this light and reflect at least some of this light to the lens 136. In one embodiment, the hood 156 can be fixed in place with respect to the light source 149, the housing 134, and the lens 136. In an alternate embodiment, however, the hood 156 might be moveable (e.g., by an actuator). The hood 156 can conceal light from the light source 149 from being passed directly from the headlight 126, and can thereby reduce any likelihood that onlookers of the headlight 126 will be temporary blinded by glare from the headlight 126.

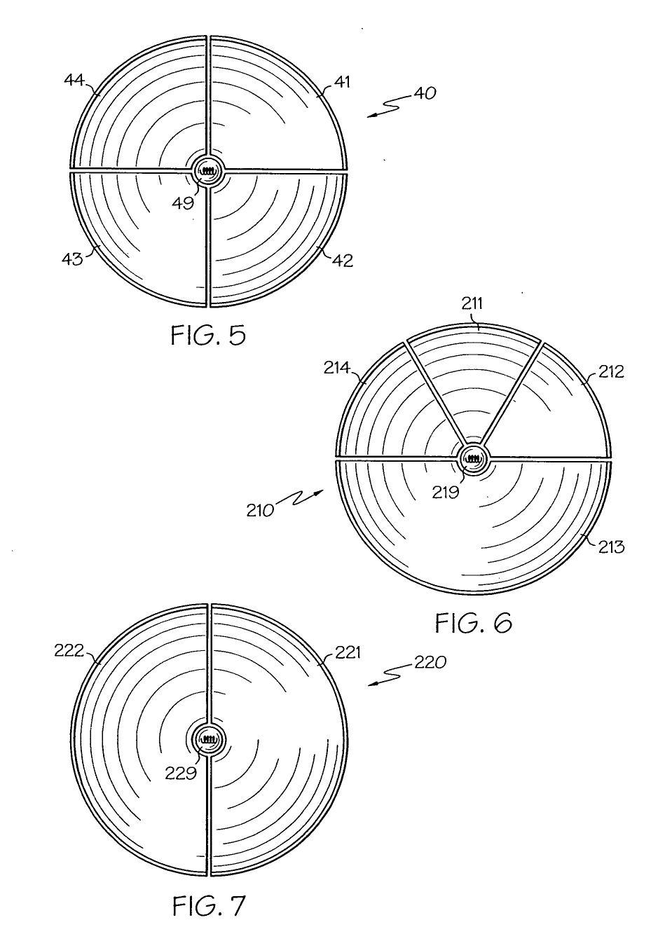

Turning now to FIG. 5, a front elevational view of the reflector assembly 40 is shown in conjunction with the light source 49. The reflector assembly 40 is shown to include four individual reflectors, namely a first reflector 41, a second reflector 42, a third reflector 43, and a fourth reflector 44. In one embodiment of the present invention, only the first and second reflectors 41, 42 might be moveable with respect to the light source 49, while the other reflectors 43, 44 are fixed in place with respect to the light source 49. In another embodiment of the present invention, only the first and fourth reflectors 41, 44 might be moveable with respect to the light source 49, while the other reflectors 42, 43 are fixed in place with respect to the light source 49. In yet another embodiment, each of the reflectors 41, 42, 43, 44 might be moveable with respect to the light source 49. Other arrangements of moveable/fixed reflectors might also be provided within the reflector assembly 40. One or more actuators can be provided to facilitate movement of the moveable reflectors, as described above. By moving one or more of these reflectors 41, 42, 43, 44, the pattern of light emitted from an associated lamp assembly can be altered dramatically. FIGS. 6-15 provide additional exemplary configurations for reflector assemblies as might be included within exemplary lamp assemblies in accordance with the teachings of the present invention.

In particular, FIG. 6 depicts a reflector assembly 210 and a light source 219. The reflector assembly 210 includes a first reflector 211, a second reflector 212, a third reflector 213, and a fourth reflector 214. The second and fourth reflectors 212, 214 might be movable with respect to the light source 219, wherein the first and third reflectors 211, 213 might be fixed in place with respect to the light source 219. Alternatively, all four reflectors 211, 212, 213, 214 might be moveable with respect to the light source 219. In still another example, the first, second and fourth reflectors 211, 212, 214 might be moveable with respect to the light source 219, while the third reflector 213 can be fixed in place with respect to the light source 219. Other arrangements of moveable/fixed reflectors might also be provided within the reflector assembly 210.

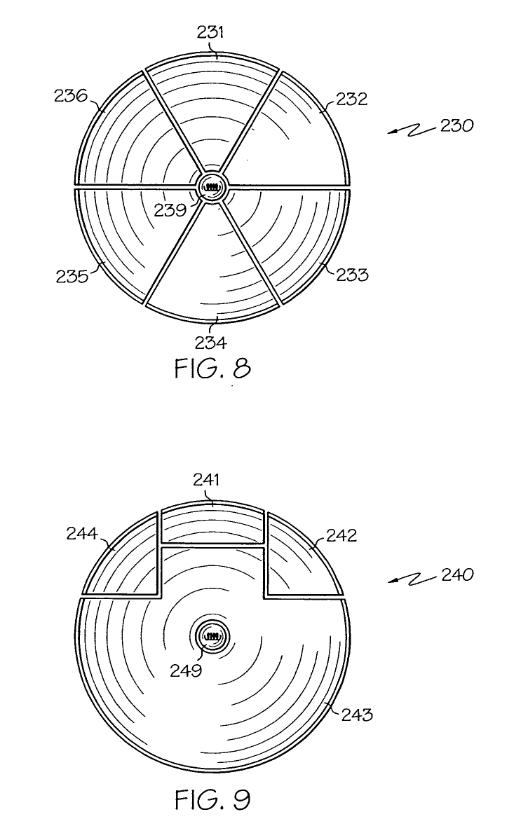

FIG. 7 depicts a reflector assembly 220 and a light source 229 wherein the reflector assembly 220 comprises a first reflector 221 and a second reflector 222. Each of these reflectors 221, 222 can be moveable with respect to the light source 229. FIG. 8 depicts a reflector assembly 230 and a light source 239, wherein the reflector assembly 230 comprises a first reflector 231, a second reflector 232, a third reflector 233, a fourth reflector 234, a fifth reflector 235, and a sixth reflector 236. Two or more of these reflectors 231, 232, 233, 234, 235, 236 can be moveable with respect to the light source 239 while the other reflectors (if any) can be fixed in place with respect to the light source 239. For example, in one particular arrangement, the second and sixth reflectors 232, 236 might be moveable with respect to the light source 239, while the other reflectors 231, 233, 234, and 235 can be fixed in place. As another example, the first, second and sixth reflectors 231, 232, 236 might be moveable with respect to the light source 239, while the other reflectors 233, 234, and 235 can be fixed in place. In still another example, all six reflectors 231, 232, 233, 234, 235, and 236 might be moveable with respect to the light source 239. Other arrangements of moveable/fixed reflectors might also be provided within the reflector assembly 230.

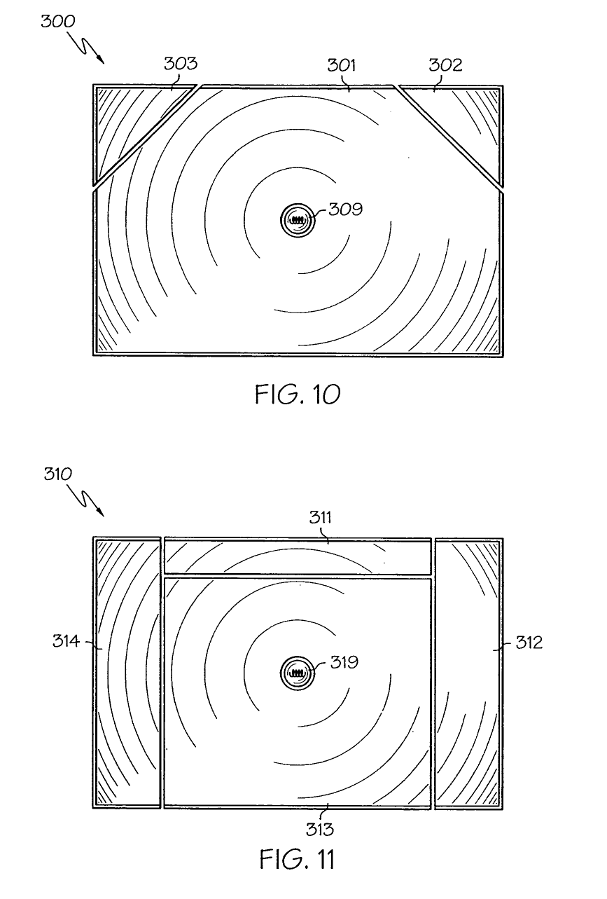

FIG. 9 depicts an alternate exemplary reflector assembly 240 and light source 249 wherein the reflector assembly 240 is shown to include a first reflector 241, a second reflector 242, a third reflector 243, and a fourth reflector 244. In one exemplary embodiment, the second and fourth reflectors 242, 244 can be moveable with respect to the light source 249, while the first and third reflectors 241, 243 can be fixed in position with respect to the light source 249. In another exemplary embodiment, the first, second and fourth reflectors 241, 242 and 244 can be moveable with respect to the light source 249, while the third reflector 243 can be fixed in place with respect to the light source 249. In still another exemplary embodiment, all four reflectors 241, 242, 243, 244 can be moveable with respect to the light source 249. Other arrangements of moveable/fixed reflectors might also be provided within the reflector assembly 240.

FIG. 10 depicts an alternate exemplary reflector assembly 300 that might, for example, be used in conjunction with a rectangular-type headlight that may be found on a vehicle. The reflector assembly 300 is shown to include a first reflector 301, a second reflector 302, and a third reflector 303. In one particular embodiment, the second and third reflectors 302, 303 can be moveable with respect to a light source 309. In another embodiment, however, all three reflectors 301, 302, and 303 can be movable with respect to the light source 309. Other arrangements of moveable/fixed reflectors might also be provided within the reflector assembly 300.

FIG. 11 depicts an alternate exemplary reflector assembly 310 and light source 319. The reflector assembly 310 is shown to include a first reflector 311, a second reflector 312, a third reflector 313, and a fourth reflector 314. In one exemplary embodiment, the first reflector 311, the second reflector 312 and the fourth reflector 314 can be all be moveable with respect to the light source 319. In another embodiment, however, all four reflectors 311, 312, 313, 314 can be moveable with respect to the light source 319. In still another embodiment, only the second and fourth reflectors 312, 314 might be moveable with respect to the light source 319. Other arrangements of moveable/fixed reflectors might also be provided within the reflector assembly 310.

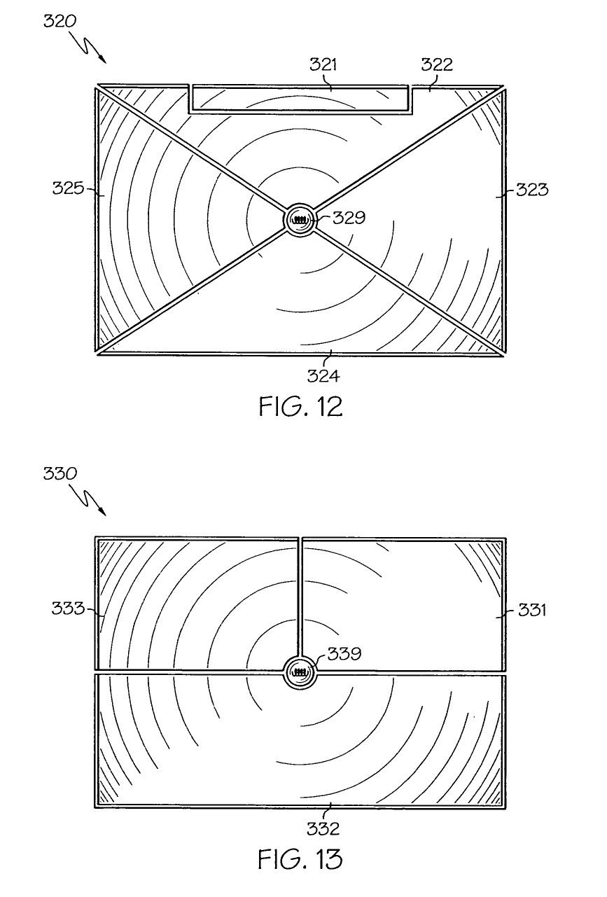

Referring now to FIG. 12, an alternate reflector assembly 320 is shown along with a light source 329. The reflector assembly 320 is shown to include a first reflector 321, a second reflector 322, a third reflector 323, a fourth reflector 324 and a fifth reflector 325. In one exemplary embodiment of the present-invention, the third and fifth reflectors 323, 325 can be moveable with respect to the light source 329, while the other reflectors 321, 322 and 324 can be fixed in place with respect to the light source 329. In another embodiment, all five reflectors 321, 322, 333, 324, 325 can be moveable with respect to the light source 329. In still another embodiment, the first, third and fifth reflectors 321, 323, 325 can be moveable with respect to the light source 329, while the second and fourth reflectors 322, 324 can be fixed in place with respect to the light source 329. Other arrangements of moveable/fixed reflectors might also be provided within the reflector assembly 320.

Turning now to FIG. 13, an alternate exemplary reflector assembly 330 is depicted in association with a light source 339. The reflector assembly 330 is shown to include a first reflector 331, a second reflector 332, and a third reflector 333. In one exemplary embodiment, the first and third reflectors 331, 333 can be moveable with respect to the light source 339, while the second reflector 332 can be fixed in place with respect to the light source 339. In an alternate embodiment, all three reflectors 331, 332, 333 can be moveable with respect to the light source 339. Other arrangements of moveable/fixed reflectors might also be provided within the reflector assembly 330.

FIG. 14 depicts a reflector assembly 410 and light source 419 that might be provided within an ovular shaped lamp assembly present on a vehicle. In particular, the reflector assembly 410 is shown to include a first reflector 411, a second reflector 412 and a third reflector 413. In one exemplary embodiment, the second and third reflectors 412, 413 can be moveable with respect to the light source 419. In another embodiment, all three reflectors 411, 412, 413 can be moveable with respect to the light source 419. Other arrangements of moveable/fixed reflectors might also be provided within the reflector assembly 410.

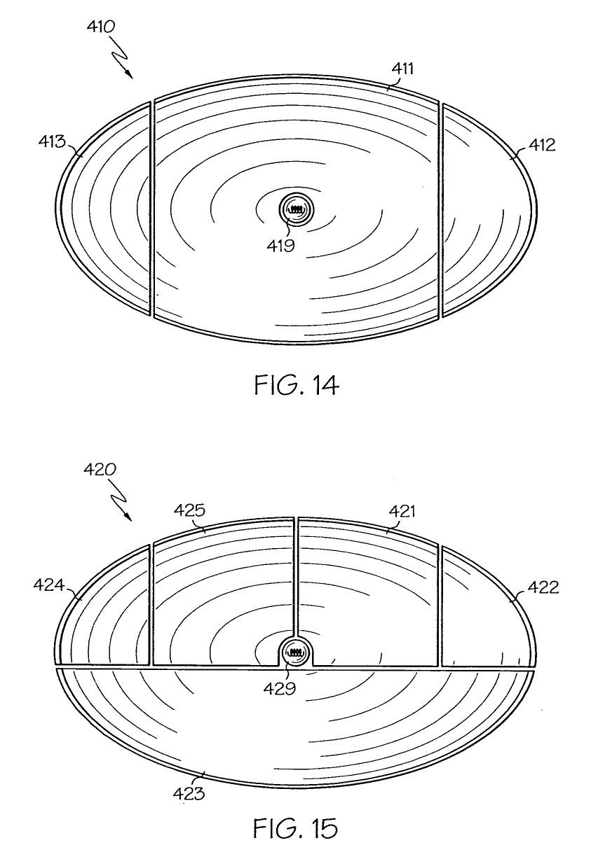

Turning now to FIG. 15, a reflector assembly 420 is shown along with a light source 429. The reflector assembly 420 is shown to include a first reflector 421, a second reflector 422, a third reflector 423, a fourth reflector 424 and a fifth reflector 425. In one exemplary embodiment, all five reflectors 421, 422, 423, 424, 425 can be moveable with respect to the light source 429. In another embodiment, only the second and fourth reflectors 422, 424 can be moveable with respect to the light source 429, while the remaining reflectors 421, 423, 425 may all be fixed in place. In still another embodiment, only the first and fifth reflectors 421, 425 may be moveable with respect to the light source 429, while the other reflectors 422, 423, 424 can be fixed in place with respect to the light source 429. Other arrangements of moveable/fixed reflectors might also be provided within the reflector assembly 420.

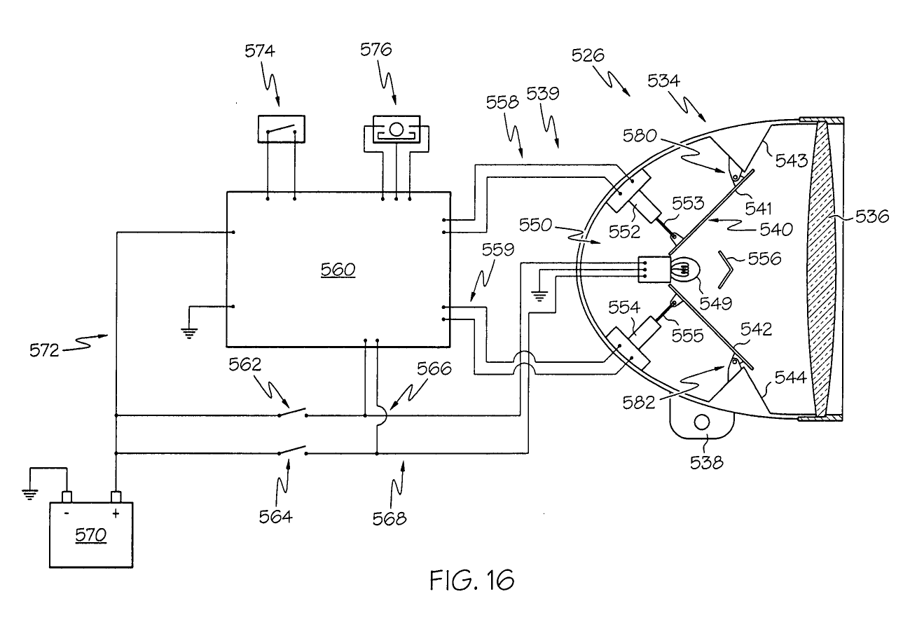

FIG. 16 depicts an exemplary lamp assembly 526 (e.g., a headlight) in association with a control system 560, as might be present upon a vehicle. In particular, the lamp assembly 526 is shown to include a housing 534, a lens 536, a light source 549, a reflector assembly 540 and an actuator assembly 550. The housing 534 can include a mounting bracket 538 for facilitating connection of the lamp assembly 526 to a vehicle.

The reflector assembly 540 is shown to include a first reflector 541, a second reflector 542, a third reflector 543, a fourth reflector 544, and a hood 556. The first and second reflectors 541, 542 are shown as being moveably connected to the housing 534 through respective hinge arrangements 580, 582. The third and fourth reflectors 543, 544 are shown as being integrally provided by internal surfaces of the housing 534, and accordingly as being fixed in place with respect to the light source 549. The actuator assembly 550 is shown to include a first actuator 552 and a second actuator 554. The first actuator 552 can include an arm 553 for interfacing the first reflector 541. Likewise, the second actuator 554 can include an arm 555 for interfacing the second reflector 542.

Wires 539 can be provided to connect with the lamp assembly 526. In particular, the wires 539 can include control wires 558 for connecting the first, actuator 552 to the control system 560, as well as control wires 559 for connecting the second actuator 554 to the control system 560. The wires 539 can also include power wires 566, 568 for connecting the light source 549 to a vehicle's electrical system which may, for example, include a battery 570. The battery 570 is shown in FIG. 16 to connect with the wire 566 through a switch 562 (which can be configured as a low-beam activation switch) and to connect with the wire 568 through a switch 564 (which can be configured as a high-beam activation switch). Although the light source 549 is depicted in FIG. 16 as a light bulb having two filaments to facilitate its use for both high-beam and low-beam headlight operation, it should be appreciated that a headlight in accordance with the teachings of the present invention might not include a light source having distinct high-beam and low-beam components (e.g., distinct filaments). Rather, such a headlight-might alternatively attain selectable high-beam and low-beam functionality through use of a single-intensity light bulb by merely selectively adjusting the positions of individual reflectors within the reflector assembly to attain desired high-beam and low-beam light patterns.

The control system 560 can receive power from the battery 570 through a wire 572, and can also be connected with wires 566, 568 in order that it may detect when power is provided to the light source 549. The control system 560 can be configured to disable operation of the actuator assembly 550 whenever power is not applied to the light source 549, thereby saving energy and preventing mechanical wear to the actuator assembly 550 and/or the reflector assembly 540.

The control system 560 can be configured to provide one or more control signals upon wires 558, 559 in order to effect movement of the first and second reflectors 541, 542. These control signals can be generated by the control system 560 in response to any of a number of stimuli. In particular, a switch 574 might be provided which, when activated, will instruct the control system 560 to adjust the reflectors 541, 542 to a predetermined position. This switch might be provided on the dashboard of a vehicle so that an operator can manually engage the switch to select which beam pattern is provided by the lamp assembly 526. Alternatively, this switch 574 can be associated with a vehicle's turn signal switch or steering wheel so that the control system 560 can automatically adjust the position of the first and second reflectors 541, 542 in response to a driver's indicated intent to turn the vehicle. The control system 560 might even comprise a tilt sensor 576 for measuring lateral tilt of a vehicle (e.g., can indicate turning of a motorcycle), whereby the control system can be configured to generate control signals in response to the lateral tilt of the vehicle as measured by the tilt sensor 576. Additional or alternative inputs might be provided to the control system 560, any or all of which can effect the movement of reflectors (e.g., 541, 542) within the lamp assembly 526. For example, the control system 560 might be configured to adjust reflector position in response to measurements of vehicle speed, daylight, precipitation (e.g., rain), road slope, or other such parameters.

Each of FIGS. 3-4 and 16 depict a reflector assembly having reflectors that are hingedly connected with the housing of a lamp assembly, but that are moveable by means of independent actuators which are connected thereto with respective arms. It should be understood that this mechanical configuration is merely exemplary, and that reflectors can be moveably disposed with respect to a light source in any of a variety of specific configurations, only a few of which configurations are specifically described herein. For example, as opposed to being hingedly connected with the housing, one or more reflectors might be solely supported upon the arm of an actuator. Also, a moveable reflector might be directly hingedly connected with another fixed or moveable reflector, such as through a living hinge or other hinge arrangement.

When multiple moveable reflectors are provided within a headlight, the light beam produced by the headlight can be precisely and automatically adjusted such that adequate light is distributed in appropriate directions ahead of the vehicle. In particular, instead of just moving the entire beam of light to the left or right, as is common of some conventional headlight arrangements, respective portions of light from the light source within a lamp assembly can be simultaneously directed in multiple distinct directions ahead of a vehicle. The pattern of light produced by such a lamp assembly can be continually and automatically adjusted by a control system such that the light pattern produced is suitable for the vehicle's speed, lateral tilt, daylight conditions, road slope, turn direction and/or other operating conditions.

This adjustment can involve actual apportionment of light among areas ahead of a vehicle. For example, if a vehicle is progressing straight along a desert highway at high speed, the reflectors within the headlight might be positioned so that almost all light from the light source is directed in a generally straight forward direction. In another example, if a vehicle is progressing straight at average speeds, the reflectors within the headlight might be positioned so that most of the light from the light source is directed straight forward, while some of the light is directed to both the left and right sides of the vehicle. In still another example, if a vehicle is traveling at very low speed, the reflectors within the headlight might be positioned so that substantially all light from the light source is evenly distributed from left to right ahead of the vehicle, and is directed downwardly. In yet another example, if a vehicle is turning, the reflectors within the headlight might be positioned so that a portion of the light from the light source is directed in the direction of the turn, while another portion of the light is directed straight forward, and another portion of the light is directed downwardly. There are many other exemplary operational aspects of such a lamp assembly. In this manner, a lamp assembly in accordance with the teachings of the present invention can selectively provide many different light patterns.

Such a lamp assembly can be particularly useful on vehicles which have a tendency to lean during turns, such as motorcycles, as the light beams generated by conventional headlights on those vehicles often lean with the vehicle, and therefore fail to adequately illuminate the roadway during the turn. Conversely, light beams generated by a headlight having multiple moveable reflectors can be quickly and automatically adjusted to compensate for the leaning (as well as turning) of the vehicle (e.g., a motorcycle). It should be appreciated that a lamp assembly in accordance with the present invention might be provided upon a motorcycle, automobile, truck, all-terrain vehicle, lawnmower, aircraft, watercraft, snowmobile, locomotive, bicycle, and/or any of a variety of other vehicles. It should also be appreciated that such a lamp assembly might be configured for use as a headlight, turn signal, brake light, spot light, fog light, driving light, marker light, utility light, and/or any of a variety of other lights present upon a vehicle.

The foregoing description of exemplary embodiments and examples of the invention has been presented for purposes of illustration and description. It is not intended to be exhaustive or to limit the invention to the forms described. Numerous modifications are possible in light of the above-teachings. Some of those modifications have been discussed and others will be understood by those skilled in the art. The embodiments were chosen and described in order to best illustrate the principles of the invention and various embodiments as are suited to the particular use contemplated. The scope of the invention is, of course, not limited to the examples or exemplary embodiments set forth herein, but can be employed in any number of applications and equivalent devices by those of ordinary skill in the art. Rather it is hereby intended the scope of the invention be defined by the claims appended hereto.

What is claimed is:

1. A vehicular headlight comprising:
a light source configured to emit light during use;
a lens;
first and second reflectors positioned to reflect light emitted from the light source through the lens, the first and second reflectors moveable with respect to the light source; and
an actuator assembly configured to move the first and second reflectors with respect to the light source in response to at least one control signal;
wherein the vehicular headlight is configured such that, during use, the first and second reflectors are positioned to reflect light from the light source through the lens.

2. The vehicular headlight of claim 1 wherein the actuator assembly comprises a first actuator and a second actuator, the first actuator connected with the first reflector and configured to adjustably position the first reflector, and the second actuator connected with the second reflector and configured to adjustably position the second reflector.

3. The vehicular headlight of claim 2 wherein the first and second actuators are configured to independently move the first and second reflectors.

4. The vehicular headlight of claim 1 wherein the actuator assembly is configured to synchronously move the first and second reflectors.

5. The vehicular headlight of claim 1 further comprising a third reflector positioned to reflect light emitted from the light source through the lens, the third reflector moveable with respect to the light source.

6. The vehicular headlight of claim 1 further comprising a third reflector positioned to reflect light emitted from the light source through the lens, the third reflector having a fixed position with respect to the light source.

7. The vehicular headlight of claim 1 further comprising a hood positioned between the light source and the lens, the hood configured to intercept and reflect toward at least one of the first and second reflectors at least some of the light emitted by the light source, the at least one of the first and second reflectors configured to intercept and reflect to the lens at least some of the light reflected by the hood.

8. The vehicular headlight of claim 1 wherein the light source comprises a light bulb.

9. The vehicular headlight of claim 1 wherein the lens has a fixed position with respect to the light source.

10. The vehicular headlight of claim 1 wherein the first and second reflectors are distinct from one another.

11. The vehicular headlight of claim 10 wherein the first and second reflectors are spaced away from one another.

12. A lamp assembly configured for attachment to a vehicle for providing illumination about the exterior of a vehicle, the lamp assembly comprising:
a light source configured to emit light during use;
a lens;
first and second reflectors positioned to reflect light emitted from the light source through the lens, the first and second reflectors being moveable with respect to the light source; and
an actuator assembly configured to move the first and second reflectors with respect to the light source in response to at least one control signal;
wherein the lamp assembly is configured such that, during use, the first and second reflectors remain positioned to continually reflect light from the light source through the lens.

13. The lamp assembly of claim 12 wherein the actuator assembly comprises a first actuator and a second actuator, the first actuator connected with the first reflector and configured to adjustably position the first reflector, and the second actuator connected with the second reflector and configured to adjustably position the second reflector.

14. The lamp assembly of claim 13 wherein the first and second actuators are configured to independently move the first and second reflectors.

15. The lamp assembly of claim 12 wherein the actuator assembly is configured to synchronously move the first and second reflectors.

16. The lamp assembly of claim 12 further comprising a hood positioned between the light source and the lens, the hood configured to intercept and reflect toward at least one of the first and second reflectors at least some of the light emitted by the light source, the at least one of the first and second reflectors configured to intercept and reflect to the lens at least some of the light reflected by the hood.

17. The lamp assembly of claim 12 wherein the light source comprises a light bulb.

18. The lamp assembly of claim 12 wherein the lens has a fixed position with respect to the light source.

19. The lamp assembly of claim 12 wherein the first and second reflectors are spaced away from one another.

20. A vehicle comprising:
a control system configured to generate at least one control signal;
a headlight comprising a light source configured to emit light during use, a lens, and first and second reflectors positioned to reflect light emitted from the light source through the lens, the first and second reflectors moveable with respect to the light source, the headlight further comprising an actuator assembly configured to move the first and second reflectors with respect to the light source in response to the at least one control signal, wherein the headlight is configured such that, during use, the first and second reflectors are positioned to reflect light from the light source through the lens.

21. The vehicle of claim 20 wherein the control system is configured to generate the at least one control signal in response to at least one of a turn signal activation, a turn of the vehicle, and engagement of a switch by an operator.

22. The vehicle of claim 20 comprising a motorcycle.

23. The vehicle of claim 22 wherein the control system further comprises a tilt sensor for measuring lateral tilt of the motorcycle, the control system configured to generate the at least one control signal in response to the lateral tilt of the motorcycle as measured by the tilt sensor.
